(19) United States
(12) Patent Application Publication
(10) Pub. No.: US 2019/0161034 A1
(43) Pub. Date: May 30, 2019

(54) GUIDE END OF CABLE GUIDE, CABLE GUIDE, AND WIRE HARNESS

(71) Applicant: SUMITOMO WIRING SYSTEMS, LTD., Mie (JP)

(72) Inventors: Kazuma ISODA, Mie (JP); Hiroki UNO, Mie (JP)

(73) Assignee: SUMITOMO WIRING SYSTEMS, LTD., Mie (JP)

(21) Appl. No.: 16/310,731

(22) PCT Filed: Jun. 5, 2017
(86) PCT No.: PCT/JP2017/020774

§ 371 Date: Dec. 17, 2018

(30) Foreign Application Priority Data
Jun. 24, 2016 (JP) 2016-125547

(51) Int. Cl. B60R 16/02; H02G 3/04; H02G 11/00

(52) U.S. Cl. CPC B60R 16/0215; H01B 7/06; H02G 11/006; H02G 3/0406

(57) ABSTRACT

Provided is a guide end of a cable guide, a cable guide, and a wire harness that can facilitate a wire harness assembling operation. A guide end is disposed at an end of a cable guide, and is rotatably held by a bracket fixed to a fixing target, the cable guide being bendable into a predetermined shape. The guide end includes a first divided part and a second divided part that are configured to divide, in a circumferential direction, an electric wire insertion hole via which electric wires passed through the inside of the cable guide are drawn to the outside, and the electric wire insertion hole is closed entirely in a circumferential direction in a state in which the first divided part and the second divided part are combined, and the electric wire insertion hole is open when the first divided part and the second divided part are not combined.

### TECHNICAL FIELD

The present invention relates to a guide end of a cable guide, a cable guide, and a wire harness.

### BACKGROUND ART

Conventionally, wire harnesses that are subjected to repeated predetermined bending actions are known, such as for example wire harnesses that supply electricity to electric components mounted in a sliding door of an automobile. For example, the wire harness disclosed in Patent Document 1 below includes a cable guide that surrounds electric wires and guides a predetermined bending action, in which end portions (guide ends) of the cable guide are rotatably held by a door-side bracket fixed to a sliding door and a body-side bracket fixed to a body. The electric wires passed through the inside of the cable guide are drawn to the outside via a harness insertion hole formed in a guide end.

### CITATION LIST

Patent Document
Patent Document 1: JP 2014-42367A

### SUMMARY OF INVENTION

### Technical Problem

However, with the above-described configuration, there is the problem that an assembling operation is not easy because, when assembling the wire harness, an operation of passing the electric wires through the harness insertion hole formed in a guide end needs to be performed.

The present invention was made in view of the aforementioned circumstances, and it is an object thereof to provide a guide end of a cable guide, a cable guide, and a wire harness that can facilitate a wire harness assembling operation.

### Solution to Problem

According to the present invention, a guide end of a cable guide is disposed at an end of the cable guide, and is rotatably held by a bracket fixed to a fixing target, the cable guide being bendable into a predetermined shape, the guide end including: a first divided part and a second divided part that are configured to divide, in a circumferential direction, an electric wire insertion hole via which electric wires passed through the inside of the cable guide are drawn to the outside, the electric wire insertion hole being closed entirely in a circumferential direction in a state in which the first divided part and the second divided part are combined, and the electric wire insertion hole being open in a state in which the first divided part and the second divided part are not combined.

According to the present invention, a cable guide includes the guide end of a cable guide.

According to the present invention, a wire harness includes the cable guide, and a plurality of electric wires passed through the cable guide.

### Advantageous Effects of Invention

According to the present invention, by laying the electric wires along one of the first divided part and the second divided part, and bringing the other one together thereto, a state is realized in which the electric wires are passed through the electric wire insertion hole, which eliminates the need of an operation of passing electric wires and thus can facilitate a wire harness assembling operation.

### BRIEF DESCRIPTION OF DRAWINGS

FIG. 1 is a diagram schematically illustrating a wire harness according to the present embodiment, in a state in which it is installed in a vehicle.

FIG. 2 is a side view illustrating a state in which a guide end of a cable guide is attached to a bracket.

FIG. 3 is a cross-sectional view taken along A-A in FIG. 2, illustrating the state in which the guide end of the cable guide is attached to the bracket.

FIG. 4 is a perspective view of the guide end of the cable guide.

FIG. 5 is a cross-sectional view taken along B-B in FIG. 4, illustrating the guide end of the cable guide.

FIG. 6 is a perspective view illustrating a first divided part and a second divided part prior to being combined.

FIG. 7 is a front view illustrating the first divided part.

FIG. 8 is a front view illustrating the second divided part.

### DESCRIPTION OF EMBODIMENTS

Hereinafter, preferred embodiments of the present invention will be described.

The guide end of a cable guide according to the present invention may further include a tubular portion that is configured to surround the electric wires, and is open in a longitudinal direction of the cable guide, wherein, in a state in which the guide end is held by the bracket fixed to the fixing target, the tubular portion includes an upper wall arranged on an upper side and a lower wall arranged on a lower side, and the first divided part has the upper wall, and the second divided part has the lower wall.

Furthermore, in the guide end of a cable guide according to the present invention, the first divided part and the second divided part are configured to be combined in a horizontal direction in the state in which the guide end is held by the bracket, and

the first divided part and the second divided part are provided with fitting structures that are configured to be slid and fitted to each other in the horizontal direction when the first divided part and the second divided part are combined, and are capable of being locked in a vertical direction in the state in which the guide end is held by the bracket. According to this configuration, even if, for example, the cable guide was stepped on and a large downward force was exerted on the second divided part, the force is taken on by the fitting structures, and thus the first divided part and the second divided part can remain combined.

### Embodiment

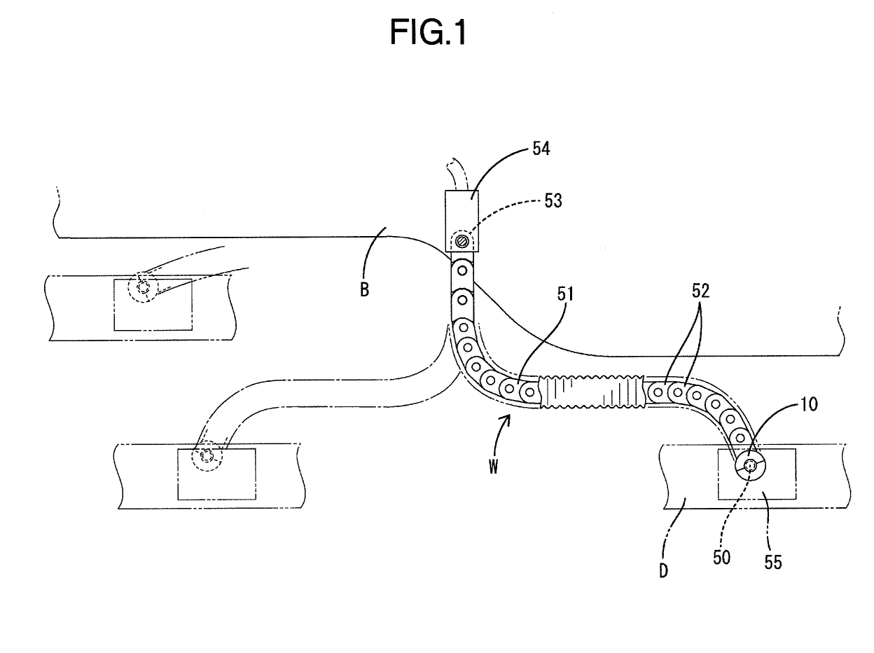

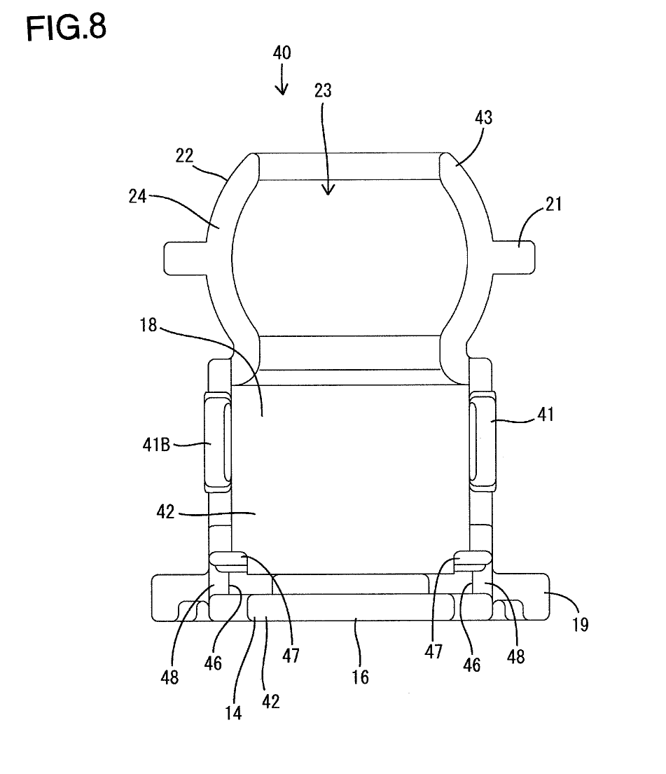

Hereinafter, an embodiment of the present invention will be described in detail with reference to FIGS. 1 to 8.

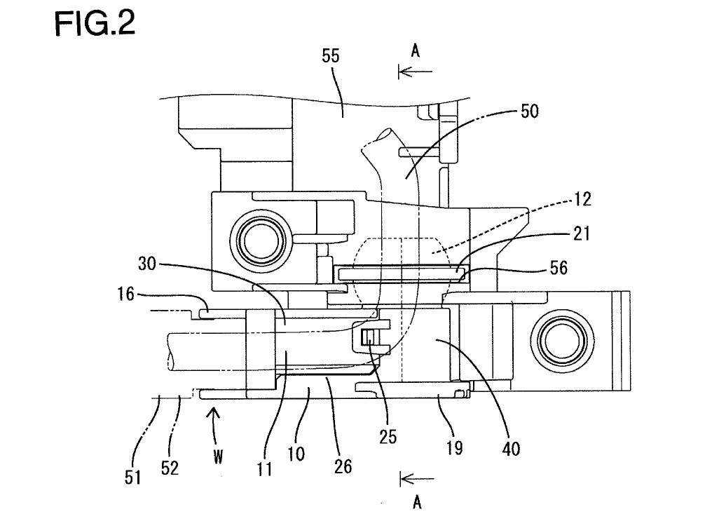

A wire harness W according to the present embodiment is a sliding door wire harness that is installed in a vehicle provided with a sliding door D, and is configured to constantly supply electricity to electric components provided in the sliding door D. The wire harness W spans a vehicle body B and the lower end of the sliding door D. The wire harness W is provided with a plurality of electric wires 50, and a cable guide 51 that is bendable into a predetermined shape within a substantially horizontal plane. In the following description, “upper” is used regarding portions of the constituent components that are located on the upper side of FIG. 2 (upper side in the state in which the wire harness W is provided in the vehicle), and “lower” is used regarding the portions thereof that are located on the lower side.

As shown in FIG. 1, the cable guide 51 is constituted by a plurality of link parts 52 that are coupled to each other so as to be able to pivot, and a bundle of the electric wires 50 is passed therethrough. The cable guide 51 has a guide end 53, which is disposed at the end thereof on the body B side and is rotatably attached to a body-side bracket 54, and a guide end 10, which is disposed at the end thereof on the sliding door D side and is rotatably attached to a door-side bracket (hereinafter, referred to simply as “bracket 55”).

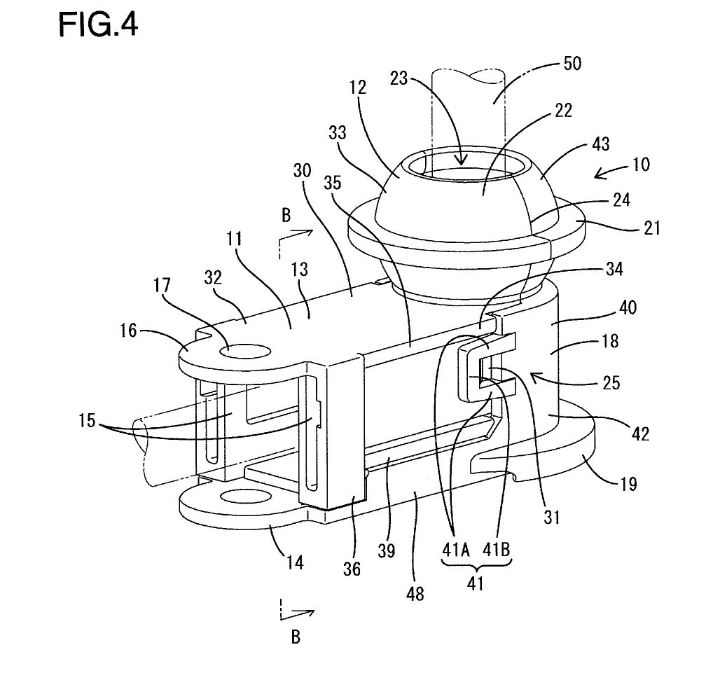

As shown in FIG. 4, the guide end 10 is provided with a tubular portion 11 that surrounds the electric wires 50 and is open in the longitudinal direction of the cable guide 51, and a rotating portion 12 that protrudes from the upper surface of the tubular portion 11. The tubular portion 11 has a rectangular cross-section, and has an upper wall 13 disposed on the upper side, a lower wall 14 disposed on the lower side, and a pair of side walls 15 between the upper wall 13 and the lower wall 14. The pair of side walls 15 stand at a substantially right angle with the upper wall 13 and the lower wall 14. The tubular portion 11 also has an end wall 18 that is provided standing at an end in the longitudinal direction of the cable guide 51. The end wall 18 is curved in an arc shape (in a semicircular shape) when viewed in a plane view, and stands at a substantially right angle with the lower wall 14.

The tubular portion 11 has, on one end side in the longitudinal direction of the cable guide 51, a coupling portion 16 that is coupled to another link part 52. In the coupling portion 16, coupling holes 17 are formed in the upper wall 13 and the lower wall 14 while penetrating therethrough in a vertical direction.

The tubular portion 11 is provided with, at the lower end thereof, a lower-side flange portion 19, which is substantially parallel to a later-described upper-side flange portion 21. The lower-side flange portion 19 is provided in an end portion opposite to the coupling portion 16, and protrudes outward from the end wall 18 along the lower surface of the tubular portion 11. The lower-side flange portion 19 is circular ring-shaped when viewed in a plane view.

The rotating portion 12 has a spherical shape as a whole, and protrudes from the upper surface in the end portion, opposite to the coupling portion 16, of the tubular portion 11. The outer surface of the rotating portion 12 is defined as a spherical surface 22, and the spherical surface 22 is formed continuously over the entire circumference and entire height of the rotating portion 12.

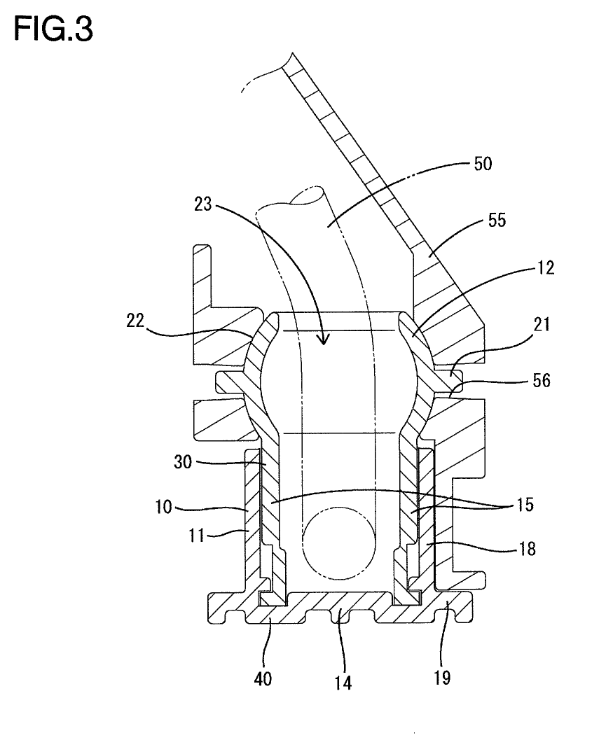

The rotating portion 12 is provided with the upper-side flange portion 21 that protrudes substantially horizontally. The upper-side flange portion 21 protrudes from the central portion in the vertical direction of the rotating portion 12 (namely, the portion thereof that has the largest diameter in the horizontal direction), so as to be able to enter a groove portion 56 of the bracket 55, as shown in FIG. 3. As a result of the upper-side flange portion 21 entering the groove portion 56, the guide end 10 is supported by the bracket 55 in a state of being suspended therefrom. The upper-side flange portion 21 continuously protrudes by a constant protrusion amount over the entire circumference of the rotating portion 12. The upper and lower surfaces of the upper-side flange portion 21 are substantially horizontal. The rotating portion 12 is up-down symmetric with respect to the upper-side flange portion 21.

As shown in FIG. 4, the rotating portion 12 has, inside thereof, an electric wire insertion hole 23 via which the electric wires 50 passed through the inside of the cable guide 51 are drawn to the outside. The electric wire insertion hole 23 has a circular cross-section, and is in communication with the inside of the tubular portion 11, while penetrating the rotating portion 12 and the upper wall 13 in the vertical direction. The axis line of the electric wire insertion hole 23 and the axis line of the tubular portion 11 are substantially orthogonal to each other.

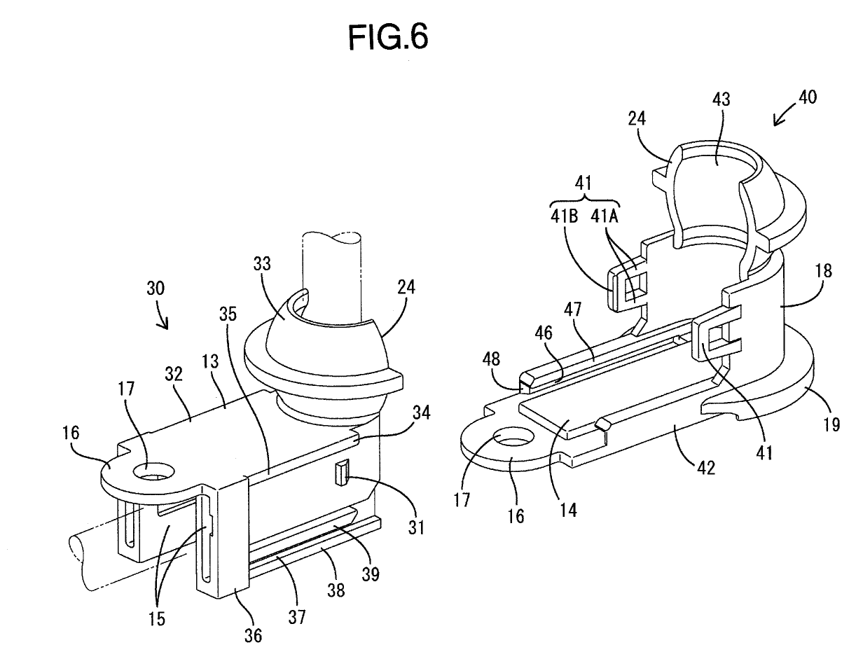

The guide end 10 includes a first divided part 30 and a second divided part 40 that divide the electric wire insertion hole 23 in a circumferential direction. As shown in FIG. 4, the electric wire insertion hole 23 is closed entirely in the circumferential direction in a state in which the first divided part 30 and the second divided part 40 are combined, and, as shown in FIG. 6, the electric wire insertion hole 23 is open in a state in which the first divided part 30 and the second divided part 40 are not combined. The first divided part 30 and the second divided part 40 are designed to be combined in the horizontal direction.

The rotating portion 12 is divided into two parts in the longitudinal direction of the cable guide 51, so that the electric wire insertion hole 23 is open in the longitudinal direction of the cable guide 51. Divided faces 24 of the rotating portion 12 are substantially perpendicular.

The guide end 10 includes locking structures 25 that are configured to lock the combined first divided part 30 and second divided part 40 to prevent them from separating from each other. The locking structures 25 include locking projections 31 and locking pieces 41 that can realize locking in the longitudinal direction (horizontal direction) of the cable guide 51.

The first divided part 30 includes part of the tubular portion 11 (hereinafter, referred to as “first tubular portion 32”) and part of the rotating portion 12 (hereinafter, referred to as “first rotating portion 33”).

As shown in FIG. 6, the first tubular portion 32 includes the upper wall 13 and the pair of side walls 15, and has a shape in which the first tubular portion 32 is open on the lower surface side and on both sides in the longitudinal direction thereof. The locking projections 31 are provided on the outer surfaces of the pair of side walls 15.

As shown in FIG. 6, the first tubular portion 32 is provided with protruding edge portions 35, which protrude outward past the side walls 15 from both edges in a short direction (width direction) of the upper wall 13. The end portions, on the first rotating portion 33 side, of the protruding edge portions 35 can be close to the end wall 18 of the second divided part 40 when the first divided part 30 and the second divided part 40 are combined, as shown in FIG. 4.

Furthermore, as shown in FIG. 6, the first tubular portion 32 is also provided with, in the end portion thereof on the coupling portion 16 side, protruding walls 36, which protrude outward from the side walls 15. The protruding walls 36 can be close to second protruding portions 47 and raised protruding portions 48 of the second divided part 40 when the first divided part 30 and the second divided part 40 are combined, as shown in FIG. 4.

As shown in FIG. 6, the first rotating portion 33 is a portion of the rotating portion 12 that is located on the center side (on the coupling portion 16 side) in the longitudinal direction of the cable guide 51, and is contiguous with the upper wall 13.

The second divided part 40 includes part of the tubular portion 11 (hereinafter, referred to as “second tubular portion 42”), and part of the rotating portion 12 (hereinafter, referred to as “second rotating portion 43”).

As shown in FIG. 6, the second tubular portion 42 includes the lower wall 14 and the end wall 18, and has a shape in which the second tubular portion 42 is open on the upper surface side and on the coupling portion 16 side in the longitudinal direction thereof. The locking pieces 41 are provided at both ends in the width direction of the end wall 18. The locking pieces 41 each include a pair of upper and lower arm portions 41A protruding almost horizontally from the end wall 18 in a cantilever fashion, and a spanning portion 41B that spans the distal ends of the pair of arm portions 41A. In the state in which the first divided part 30 and the second divided part 40 are combined as shown in FIG. 4, the spanning portions 41B are locked with the locking projections 31 in the horizontal direction (combined direction), and the locking projections 31 fit between the upper and lower arm portions 41A.

As shown in FIG. 6, the second rotating portion 43 is a portion of the rotating portion 12 that is located on the end side (opposite to the coupling portion 16) in the longitudinal direction of the cable guide 51, and is contiguous with the end wall 18.

The first divided part 30 and the second divided part 40 are provided with fitting structures 26 that are slid and fitted to each other in the horizontal direction. The fitting structures 26 are provided on two sides of the guide end 10 so as to be fitted to each other in a recess-projection manner, and have a shape of extending in an elongated manner in the horizontal direction (sliding direction).

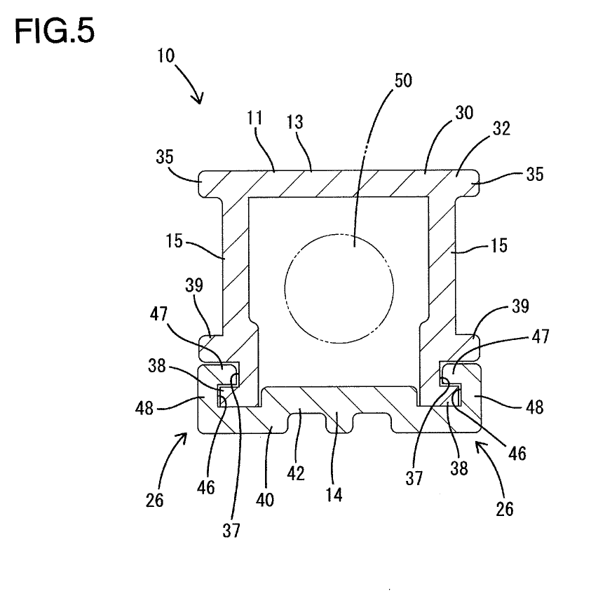

As shown in FIG. 5, the fitting structures 26 include first groove portions 37 and first protruding portions 38 that are provided on the first divided part 30, and second groove portions 46 and second protruding portions 47 that are provided on the second divided part 40. The first protruding portions 38 are designed to be fitted to the second groove portions 46, and the second protruding portions 47 are designed to be fitted to the first groove portions 37.

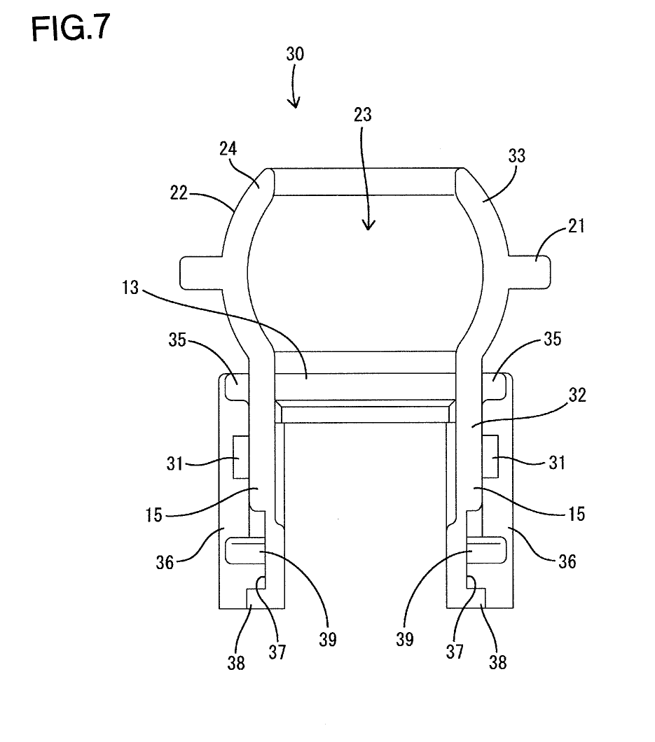

As shown in FIG. 6, the first groove portions 37 are grooves that are open sideways, and extend continuously along the lower edge portions of the side walls 15. As shown in FIG. 7, each first groove portion 37 has upper and lower surfaces that are substantially parallel to each other. The first groove portions 37 are formed between the first protruding portions 38 and upper protruding portions 39 provided above the first protruding portions 38.

As shown in FIG. 7, the first protruding portions 38 protrude sideways along the lower end portions of the side walls 15. The first protruding portions 38 extend over the entire length of side walls 15 in the longitudinal direction, as shown in FIG. 6.

As shown in FIG. 7, the upper protruding portions 39 are substantially parallel to the first protruding portions 38. The upper protruding portions 39 have a protrusion length that is greater than that of the first protruding portions 38. As shown in FIG. 6, the upper protruding portions 39 continuously extend to the same positions as the ends of the corresponding protruding edge portions 35. The end portions, on the first rotating portion 33 side, of the respective upper protruding portions 39 can be close to the end wall 18 of the second divided part 40 when the first divided part 30 and the second divided part 40 are combined, as shown in FIG. 4.

As shown in FIG. 5, the second groove portions 46 are formed between the lower wall 14 and second protruding portions 47. The second protruding portions 47 protrude inward from upper edges of the raised protruding portions 48, which stand along the left and right edges of the lower wall 14. As shown in FIG. 6, the second protruding portions 47 and the raised protruding portions 48 extend continuously from both edge portions, in the width direction, of the end wall 18 to positions close to the coupling portion 16. The end portions, on the coupling portion 16 side, of the second protruding portions 47 and the raised protruding portions 48 can be close to the protruding walls 36 of the first divided part 30 when the first divided part 30 and the second divided part 40 are combined, as shown in FIG. 4.

The following will describe an example of an operation for assembling the wire harness W according to the present embodiment.

First, not-shown connectors are connected to end portions of the electric wires 50. Terminal fittings are crimped with terminal portions of the electric wires 50, and the terminal fittings are inserted into the connectors.

Then, the electric wires 50 are laid along the first divided part 30 (see FIG. 6). The bundle of electric wires 50 drawn from the link parts 52 of the cable guide 51 is accommodated in the first tubular portion 32 and is bent toward the first rotating portion 33, and as a result, a state is realized in which the bundle of electric wires 50 is fitted to the upper wall 13 and the inner surface of the first rotating portion 33. The connectors should be placed above the first rotating portion 33.

Then, the second divided part 40 is brought together to the first divided part 30. The lower wall 14 of the second divided part 40 is slid so as to be fitted to the open side of the first tubular portion 32. As shown in FIG. 5, the first protruding portions 38 of the first divided part 30 are inserted into the second groove portions 46 of the second divided part 40, and the second protruding portions 47 of the second divided part 40 are inserted into the first groove portions 37 of the first divided part 30. With the fitting structures 26, a sliding operation (combining operations) of the first divided part 30 and the second divided part 40 is guided smoothly. Then, as shown in FIG. 4, a state in which the divided faces 24 of the rotating portion 12 adhere to each other, and the bundle of electric wires 50 is passed through the electric wire insertion hole 23 is realized. Furthermore, the locking pieces 41 that have moved over the locking projections 31 and have elastically returned are locked with the locking projections 31. Accordingly, the first divided part 30 and the second divided part 40 are combined, and thus the guide end 10 is formed.

Then, the guide end 10 is coupled to the link parts 52, and assembly of the cable guide 51 is complete.

With the above-described procedure, the operation for assembling the wire harness W is complete.

The following will describe functions and effects of the embodiment having the aforementioned configurations.

The guide end 10 of the cable guide 51 according to the present embodiment is disposed at an end of the cable guide 51, and is rotatably held by the bracket 55 fixed to the sliding door D, the cable guide 51 being bendable into a predetermined shape, and the guide end 10 has the electric wire insertion hole 23 via which the electric wires 50 passed through the inside of the cable guide 51 are drawn to the outside. The guide end 10 includes the first divided part 30 and the second divided part 40 that divide the electric wire insertion hole 23 in the circumferential direction, and the electric wire insertion hole 23 is closed entirely in the circumferential direction in the state in which the first divided part 30 and the second divided part 40 are combined, and the electric wire insertion hole 23 is open in the state in which the first divided part 30 and the second divided part 40 are not combined.

According to this configuration, by laying the electric wires 50 along the first divided part 30, and bringing the second divided part 40 together thereto, the state is realized in which the electric wires 50 are passed through the electric wire insertion hole 23, which eliminates the need of an operation of passing the electric wires 50 and thus can facilitate an operation for assembling the wire harness W.

Furthermore, the first divided part 30 and the second divided part 40 are configured to be combined in the horizontal direction, and are provided with the fitting structures 26 that are slid and fitted to each other in the horizontal direction and can be locked in the vertical direction. According to this configuration, if, for example, the cable guide 51 was stepped on and a large downward force was exerted on the second divided part 40, the second protruding portions 47 abut against the first protruding portions 38 in the vertical direction, and the large downward force is distributed and is taken on by the first protruding portions 38. Accordingly, even if a large downward force is exerted on the second divided part 40, the first divided part 30 and the second divided part 40 can remain combined.

### Other Embodiments

The present invention is not limited to the foregoing embodiment explained in the description above made with reference to the drawings, and the technical scope of the present invention encompasses, for example, the following embodiments.

(1) The foregoing embodiment has described a case where the present invention is applied to the guide end 10 on the sliding door D side, but the present invention may also be applied to the guide end on the body side.

(2) The foregoing embodiment has described a case where the present invention is applied to the wire harness W for sliding doors, but the present invention may also be applied to various types of wire harnesses (such as a wire harness to be connected to a sliding seat, for example) provided with a cable guide that is bendable into a predetermined shape.

(3) Although, in the foregoing embodiment, the specific shapes of the fitting structures 26 are shown as examples, the present invention is not limited to those, and the fitting structures may also be dovetail-groove fitting structures.

(4) Although, in the foregoing embodiment, the specific shapes of the locking structures 25 are shown as examples, the present invention is not limited to those, and the locking structures may be modified.

(5) Although, in the foregoing embodiment, the rotating portion 12 is divided in the longitudinal direction of the cable guide 51, the present invention is not limited to this, and the rotating portion may also be divided in the short direction (width direction) of the cable guide, for example.

(6) Although, in the foregoing embodiment, the specific shapes of the first divided part 30 and the second divided part 40 are shown as examples, the present invention is not limited to those, and the shapes of the first divided part and the second divided part may be modified suitably.

### LIST OF REFERENCE NUMERALS

D . . . Sliding door (fixing target)
W . . . Wire harness
10 . . . Guide end
11 . . . Tubular portion
13 . . . Upper wall
14 . . . Lower wall
23 . . . Electric wire insertion hole
26 . . . Fitting structure
30 . . . First divided part
40 . . . Second divided part
50 . . . Electric wire
51 . . . Cable guide
55 . . . Bracket

1. A guide end of a cable guide that is disposed at an end of the cable guide, and is rotatably held by a bracket fixed to a fixing target, the cable guide being bendable into a predetermined shape, the guide end comprising:
a first divided part and a second divided part that are configured to divide, in a circumferential direction, an electric wire insertion hole via which electric wires passed through the inside of the cable guide are drawn to the outside,
the electric wire insertion hole being closed entirely in a circumferential direction in a condition in which the first divided part and the second divided part are combined, and the electric wire insertion hole being open in a condition in which the first divided part and the second divided part are separated,
the guide end further comprising a tubular portion that is configured to surround the electric wires, and is open in a longitudinal direction of the cable guide, the tubular portion including an upper wall arranged on an upper side and a lower wall arranged on a lower side,
the first divided part including the upper wall, and the second divided part including the lower wall, and
the first divided part and the second divided part being configured to be combined in a horizontal direction, the first divided part and the second divided part including fitting structures that are configured to be slid and fitted to each other in the horizontal direction when the first divided part and the second divided part are combined, and are capable of being locked in a vertical direction in the condition in which the guide end is held by the bracket.

2. (canceled)

3. (canceled)

4. A cable guide comprising,
the guide end of the cable guide according to claim 1.

5. A wire harness comprising:
the cable guide according to claim 4; and
a plurality of electric wires passed through the cable guide.
